(19) United States
(12) Patent Application Publication
(10) Pub. No.: US 2009/0277850 A1
(43) Pub. Date: Nov. 12, 2009

(54) Implantable Fluid Separation System

(76) Inventors: Theodore P. Adams, Edina, MN (US); William Jehn Rissmann, Deephaven, MN (US); Bruce Alan Brillhart, Minnetonka, MN (US); John H. Wang, Waytata, MN (US)

Correspondence Address: Matthew Pasulka, 17103 North 63rd Place, Osseo, MN, 55311, US

(21) Appl. No.: 12/463,835

(22) Filed: May 11, 2009

Related U.S. Application Data
(60) Provisional application No. 61/127,140, filed on May 12, 2008.

(51) Int. Cl. B01D 29/66; B01D 39/14; B01D 21/30

(52) U.S. Cl. 210/798; 210/500.21; 210/500.24; 210/500.41; 210/137; 210/791

(57) ABSTRACT

An implantable fluid separator having a housing holding a membrane which allows fluid to pass through. The fluid is drained from the housing and removed from the body.

This application claims priority from Provisional Application No. 61/127,140 Implantable Fluid Separation System filed May 12, 2008, which is incorporated herein by reference.

### BACKGROUND OF THE INVENTION

1. Field of the Invention

This invention relates to devices to remove excess fluid from the body and improvements therein.

2. Introduction to the Invention

Fluid resides within the body as both intracellular and extracellular fluid. The extracellular fluid is primarily made up of plasma that circulates in the blood and interstitial fluid that surrounds the cells within the body's tissues. Fluid retention (edema) occurs when excess interstitial fluid is not effectively removed from the tissues.

The two broad categories of fluid retention include generalized edema, when swelling occurs throughout the body and localized edema when particular parts of the body are affected.

Edema may be symptomatic of serious medical conditions such as heart, kidney or liver disease where the organ has failed or is failing. Kidney disease, such as nephritic syndrome and acute glomerulonephritis, causes edema. If the heart does not pump effectively, the body compensates in various ways. It starts to retain fluid and increase the volume of blood. This results in congestion of the veins, enlargement of the liver, and the accumulation of fluid in body cavities like the abdominal cavity (ascites) and in subcutaneous tissues, causing swelling (edema) of the legs. With some types of arthritis, affected joints tend to swell with fluid. Also, certain drugs, including high blood pressure medication (antihypertensives), corticosteroids and nonsteroidal anti-inflammatory drugs (NSAIDs) are known to cause fluid retention.

Some of the options used to treat fluid retention are: a low salt diet; diuretics (water pills); treatment for the underlying medical condition: for example, hormone replacement (thyroxin) in the case of hypothyroidism; lifestyle changes in response to the underlying medical condition: for example, avoidance of alcohol if liver disease is the cause; changes to medication or dosage, if drugs are the cause; dietary adjustments, if malnutrition is the cause; ongoing medical supervision; and aids such as support stockings.

But for serious cases, large kidney dialysis machines are used to remove bodily waste and reduce fluid retention. Dialysis can replace part of the function of the kidneys. Hemodialysis cleans and filters blood using a machine to temporarily rid the body of harmful wastes, excess salt, and excess water. Hemodialysis helps control blood pressure and helps the body keep the proper balance of important chemicals such as potassium, sodium, calcium, and bicarbonate. Hemodialysis uses a special filter called a dialyzer that functions as an artificial kidney to clean the blood. The dialyzer is a canister connected to the hemodialysis machine.

During treatment, blood travels through tubes into the dialyzer, which filters out wastes, and excess salt. Then the cleaned blood flows through another set of tubes back into the body. The hemodialysis machine monitors blood flow and removes the wastes and excess salt from the dialyzer.

Hemodialysis is usually done three times a week. Each treatment lasts from 3 to 5 hours. During treatment, you must remain stationary in a bed or chair and can read, write, sleep, talk, or watch TV. Although the benefits of hemodialysis are high, the drawbacks are also very significant. A kidney dialysis machine is non-implantable and too large to effectively be mobile so a patient is tied to a location. The multiple treatment times a week greatly hinders “normal” lifestyles and activities such as work or school. The hemodialysis machine removes large amounts of electrolytes and often there are vascular access problems. Additionally, patients often complain about the special diets that they must adhere to in order to minimize complications and time on the machine.

Vascular access problems are the most common reason for hospitalization among people on hemodialysis. Common problems include infection, blockage from clotting, and poor blood flow. These problems can keep treatments from working. One may need to undergo repeated surgeries in order to get a properly functioning access. Other problems can be caused by rapid changes in the body's water and chemical balance during treatment. Muscle cramps and hypotension—a sudden drop in blood pressure—are two common side effects. Hypotension can make a patient feel weak, dizzy, or nauseous.

Another current treatment is peritoneal dialysis. Peritoneal dialysis performs essentially the same function and avoids some of the drawbacks of dialysis but has new problems that are similarly detrimental.

Peritoneal dialysis works by placing a mixture of minerals and sugar dissolved in water, called dialysis solution, through a catheter into the abdomen. The sugar—called dextrose—draws wastes, chemicals, and extra water from the tiny blood vessels in the peritoneal membrane into the dialysis solution. After several hours, the used solution is drained from the abdomen through the tube, taking the wastes from one's blood with it. Then the abdomen is refilled with fresh dialysis solution, and the cycle is repeated daily. The process of draining and refilling is called an exchange. The most common problem with peritoneal dialysis is peritonitis, a serious abdominal infection. This infection can occur if the opening where the catheter enters the body becomes infected or if contamination occurs as the catheter is connected or disconnected from the bags. Peritonitis requires antibiotic treatment by a doctor.

To avoid peritonitis, one must be careful to follow procedures exactly and learn to recognize the early signs of peritonitis, which include fever, unusual color or cloudiness of the used fluid, and redness or pain around the catheter. By reporting these signs to a doctor or nurse immediately, peritonitis can be treated quickly to prevent additional problems.

In addition to these problems, it is a continuous treatment, and all exchanges must be performed 7 days a week. Although one does not have to go to a treatment center, one the process is highly disruptive of a normal daily schedule.

Sometimes referred to as “water on the brain,” hydrocephalus can cause babies' and young children's heads to swell to accommodate the excess fluid. Older kids, whose skull bones have matured and fused together, experience painful headaches due to increased pressure in the head. It occurs when cerebral spinal fluid (CSF)—the clear, water-like fluid that surrounds and cushions the brain and spinal cord—is unable to drain from the brain. It then pools, causing a backup of fluid in the skull.

Shunt procedures, which have been the standard of care for decades, involve surgically implanting one end of a catheter (flexible tube) into a ventricle of the brain and placing the other end in the abdominal cavity, chambers of the heart, or space around the lungs where fluid is drained and absorbed by the bloodstream. A valve in the shunt system regulates flow to prevent over-draining and under-draining. While shunting is often an effective treatment for hydrocephalus, there is a high chance of failure and complications. About 30% of shunts will stop working within the first year, with about 5% failing in each subsequent year, causing symptoms to recur. A child will need to have surgery to correct the problem—whether it requires replacing a catheter or valve or replacing the entire shunt. Most kids who undergo shunting will require subsequent operations over their lifetimes to regulate shunt problems.

### SUMMARY OF THE INVENTION

The present invention overcomes these shortcomings in the prior art. A device made according to the present disclosure may be sized to remove at least approximately 50 cc of waste fluid and up to 1000 cc and even in some cases up to about 4,000 cc of waste fluid in a 24-hour period. With this flexibility, a wide variety of conditions may be treated. One can accomplish this by adjusting any one or multiple factors including waste fluid outflow rates, porosity of the membrane, fluid pressures, blood flow rates, pressure drops, filter membrane area, shape of the membrane, size of the filter membrane pores, multiple layers of the membrane, thickness of the membrane, distribution of the pores, the density of the filter, the pore shape and time available to flow. An implantable fluid filtration device with replaceable filter, a fluid filtration input port, a filtration fluid output port and a waste fluid output port wherein the replaceable filter comprises a membrane material overcomes these shortcomings.

Another feature of this device is that the device should have a displacement volume of less than or equal to 400 cc to fit physiologically in an adult human (180 lbs), to be acceptable to the patient and to be fully implantable. In small patients and in other patients where the amount of fluid removal may be at the low end, smaller devices may be used or may be physiologically necessary.

Another embodiment of the invention is an implantable fluid removal device that is capable of regulating the rate of removal of waste fluid using intermittent, adjustable, programmable or feedback regulated control. Additionally, feedback regulated control may measure constituents in either the blood or the separated waste product, or both, and adjust the rate of fluid removal, or the composition of the fluid removed, based on a decision algorithm. Examples of measured constituents are sodium and potassium.

Yet another embodiment of the invention is an implantable fluid removal device that removes less than or equal to a total of 50 grams of electrolyte, for example, sodium or potassium, in a 24-hour period, and additionally less than or equal to 5 grams per hour. By limiting the rate and amount of electrolytes removed, blood chemistry will be better balanced by allowing the body time to more naturally, if not completely, compensate for any salt or electrolyte imbalances.

In still yet another embodiment of the invention, an implantable fluid removal device has a filter or filter membrane that may remain in the body at least 14 days before filter servicing or replacement. The filter membrane may be made of a microporous material comprising at least one of PTFE, expanded PTFE, polyethersulfone (PES) or polyurethane.

In another embodiment of the invention, the filter may be regenerated, cleaned, refilled or renewed so that the costs and inconvenience of additional medical or surgical intervention may be reduced. Hereinafter, replaceable filter (membrane) or replacing the filter (membrane) shall mean not only filter replacement, but also regenerating, cleaning, refilling, renewing, altering, modifying, supplementing, among others, the filter so that the fluid separator continues to operate.

Another embodiment comprises an implantable fluid removal device with a replaceable filter membrane, capable of being replaced surgically or non-surgically, for example, surgically through general surgical methods, surgically by access through a vein or an artery, surgically by access through the bladder, non-surgically by access through the urethra, or non-surgically through an access port. Surgically means a medical procedure that requires cutting open the skin to access the internal body of the patient.

Still another embodiment of the invention is an implantable fluid removal device that has a filter membrane with porosity that allows passage of only fluid and particles of less than 5 microns in size.

Another embodiment of the invention comprises an implantable fluid removal device that has a blood volume flow rate of greater than or equal to 10 cc per minute. This flow rate helps keep the blood from clotting or otherwise clogging the filter, and may allow higher rates of waste fluid removal per unit area of filter membrane. Reduced filter clogging will extend filter lifetime between replacement or servicing, and also improve filter performance. Reduced clotting reduces the risks of harm to the patient due to blood clots that may cause strokes, heart attacks, or otherwise compromise patient health.

Another embodiment of the invention comprises an implantable fluid removal device having a blood laminar flow velocity over the filter medium of greater than or equal to 1.0 mm (0.1 cm) per second. In yet another embodiment the structure of the device keeps the blood flow generally laminar. By keeping the blood flow laminar, it will help reduce clots, reduce filter clogging, extend filter lifetime, improve filter performance and reduce variability in filter performance.

Another embodiment of the invention is an implantable fluid removal device where the material that comes in contact with the blood is coated with an inert or bioactive material to improve functionality, for example coating with heparin to reduce blood clot formation, Teflon to reduce clot adhesions, or drug eluting material to provide a consistent and persistent pharmacological effect.

In still another embodiment of the invention an implantable fluid removal device delivers the waste fluid into the urinary tract, the ureter, the bladder, the urethra, an internal holding device such as a bag, or delivers the waste fluid external to the body, for example through an access port.

The structure of the implantable fluid separation system in which the separator element comprises an input fluid port, a desired fluid output port, an undesired fluid output port and separation means. The separator element, in conjunction with separation means, is to separate preferentially the constituents of fluid presented at the input port, passing desired constituents to the desired output port and discharging undesired constituents to the undesired output port. In addition, the separator element provides access to the separation means, allowing the properties of the separation means to be modified without requiring the separator element to be explanted. The modification of the separation means includes, but is not limited to, retrieval, replacement, regeneration, recharge, replenishment, upgrade and/or downgrade. The inventors contemplate access to separation means not only if the separation means performance is reduced or depleted, but also in situations where the characteristics of the separation means are modified to meet changing performance requirements.

### BRIEF DESCRIPTION OF THE DRAWINGS

FIG. 1 is a schematic of one embodiment of the invention of an implantable fluid removal device;

FIG. 2 is a schematic of another embodiment of the invention of an implantable fluid removal device;

FIG. 3 is a schematic of another embodiment of the invention of an implantable fluid removal device;

FIG. 4 is a schematic of a filter according to an embodiment of the invention;

FIG. 5 is a diagrammatic representation of a possible implantation location of an embodiment of the invention;

FIG. 6 is a schematic showing connections from the device to the body according to one embodiment of the invention;

FIG. 7 is a schematic showing a fluid removal device according to another embodiment of the invention;

FIG. 8 is a schematic showing a fluid removal device according to another embodiment of the invention;

FIG. 9 is a schematic showing a fluid removal device according to another embodiment of the invention;

FIG. 10 is a schematic showing a fluid removal device according to another embodiment of the invention;

FIG. 11a is a schematic showing a fluid removal device according to another embodiment of the invention;

FIG. 11b is a sectional view along lines A-A in FIG. 11a;

FIG. 12a is a schematic showing a fluid removal device according to another embodiment of the invention;

FIG. 12b is a sectional view along lines A-A in FIG. 12a;

FIG. 13a is a schematic showing a fluid removal device according to another embodiment of the invention;

FIG. 13b is a sectional view along lines A-A in FIG. 12a;

FIG. 14 is a schematic showing a fluid removal device according to another embodiment of the invention;

FIG. 15 is a schematic showing a fluid removal device according to another embodiment of the invention;

FIG. 16 is a schematic showing a fluid removal device according to another embodiment of the invention;

FIG. 17 is a schematic showing a fluid removal device according to another embodiment of the invention;

FIG. 18 is a schematic showing a fluid removal device according to another embodiment of the invention;

FIG. 19 is a schematic showing a fluid removal device according to another embodiment of the invention;

FIG. 20 shows the removal of a membrane in one embodiment of the invention;

FIG. 21 shows the removal of a membrane in another embodiment of the invention;

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

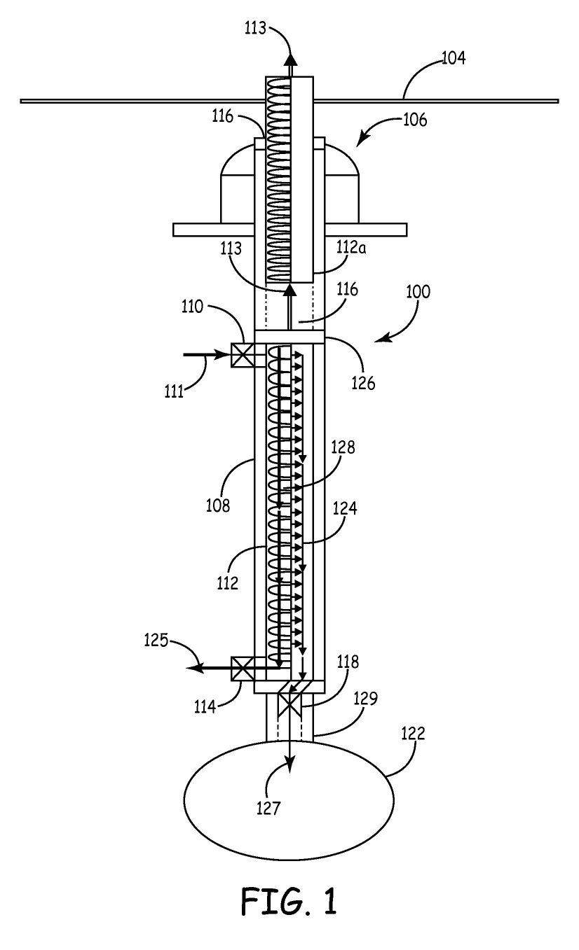

Referring now to the drawings, FIG. 1 shows an embodiment of a fluid removal device. The structure is an implantable device 100 that has an access port 106 through the skin 104. The access port 106 may be made in any number of configurations, in this embodiment a subcutaneous access port 106 is shown. However, other configurations may be used depending on a number of various factors including body type, age of patient, gender, health of patient, available abdominal space among other things. The port 106 may be self-sealing or capped with a biocompatible cover that can be removed to access the fluid removal device.

The access port 106 provides access to the housing 108 of the filter 112a device through a filter removal cannula 116 along arrows 113. The housing 108 of the device comprises an inlet valve 110 positioned at one end of the housing 108 and an outlet valve 114 at another end of the housing 108. The inlet valve 110 opens to allow the flow of blood 111 into the filter 112.

The filter 112 may be constructed in a variety of ways. In one embodiment the filter 112 is a micro-porous membrane that has one or more micro-porous layers that prevent blood cells and proteins from flowing through the membrane but allow water and limited amounts of electrolytes and wastes to flow through the membrane in various quantities depending on, among other things, the size of the pores, the blood flow rate and blood pressure. The pore size may range from atomic size to just smaller than red blood cell (RBC) size. The pore size, including pore shape and distribution, determines the components of blood that are removed. If the pores are large, all but RBCs and proteins will be filtered from the blood. As the pores get smaller, the filter will not only prevent the RBCs and proteins from being filtered from the blood but also other smaller blood components. If the pores are small enough, they will only allow water and limited amounts of electrolytes and body wastes to be filtered from the blood. Depending on the need of a patient to remove the various components, a doctor may prescribe the filter pore shape or size. Because of the replaceability of the filter membrane, a filter may remain implanted for acute or chronic periods of time.

In another embodiment, the filter may comprise a helix or spiral blood flow path, whereby, as the blood passes over the filter membrane, only the smallest elements 127 of the blood have permeability through the filter element 128 which are collected in the collector 124 and passed through a disposal cannula 129 disposed of in either the bladder 122 or elsewhere. The remaining elements 125 will be returned. The remaining elements may be returned to either arterial or venous systems of the body.

It is important to design the filter to have certain tangential flows and shear stresses that are high enough to sweep off proteins & platelets and keep from them from binding to the surface of the housing or filter element; and, low enough to prevent platelet activation and hemolysis. In one embodiment the inner diameter of at least one of potentially multiple tubular filter membranes would be at least about 6 mm and about no more than about 10 mm to achieve appropriate tangential flows and shear stresses.

The filter housing preferably has a hemostasis valve 126 so that the filter is replaceable. Additionally a check valve or flow restrictor 118 should be placed between the collector 124 and the bladder 122 or the like. This prevents backflow into the collector 124 which would then cross the filter element 128 thereby putting waste into the blood through the filter. Also, a flow restrictor may be placed on inlet valve 110 or outlet valves 114 keeps a person from bleeding to death if there is a rupture in the filter or the filter otherwise fails.

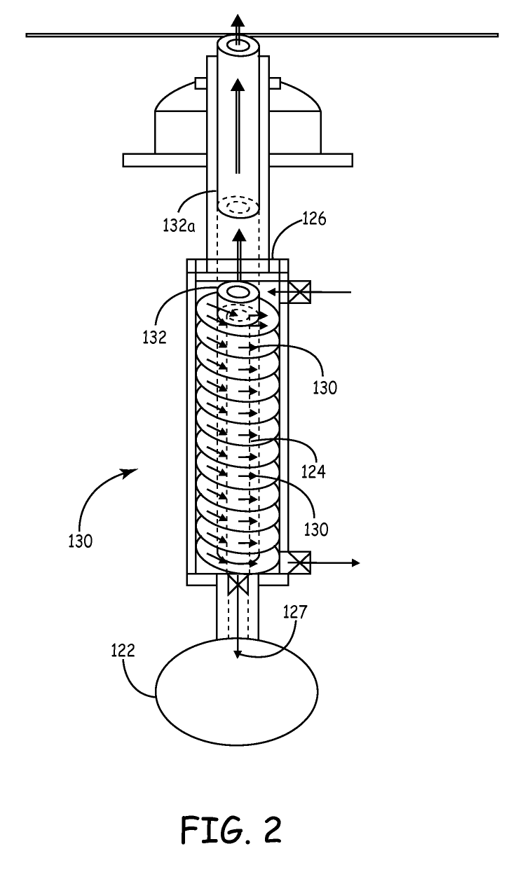

In another embodiment, shown in FIG. 2, the device performs a similar function, the removal of fluid and wastes, but replaceable filter element 132 comprises a different component. In contrast with the embodiment of FIG. 1, the filter element shown has a single tubular membrane in comparison to at least one or more tubular membranes. The path for the blood is a helical channel 130 that exposes the blood to the filter element 132. The purpose of the channel is to increase the time the blood is in contact with the filter element 132. The filter element 132 is removable through the hemostasis valve 126.

In order to reduce the risk of allowing air into the blood stream, different methods and devices may be used to reduce the air entrained in a filter. In one embodiment minimal pre-wetting is used to eliminate trapped air (denucleation) within the wall microstructure to facilitate water passage through wall; and to maintain a level of surface and intra-wall hydrophobicity that minimizes protein fouling because the blood-air interface denatures plasma proteins and activates clotting factors and platelets. It may also be accomplished by thoroughly massaging isotonic saline into tube wall to pre-wet the entire wall microstructure.

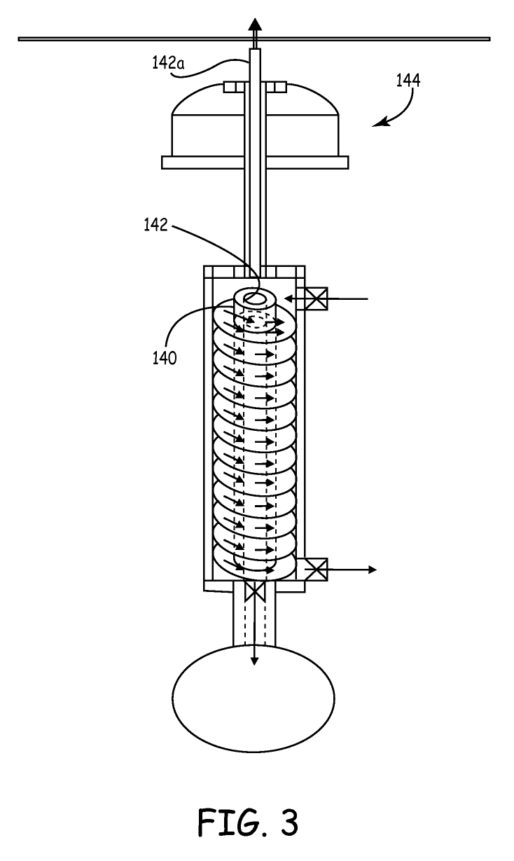

In FIG. 3, in another embodiment, filter element 140 is lined with a membrane 142. The membrane liner 142 may be on the outside or inside of the filter element. The liner 142 (142a in a different position) is removable through the access port 144. The liner 142 may comprise a reactive agent that fixes waste to the surface. As the reactive agent gets used, the efficacy of the liner 142 may diminish. As the efficacy of the filter diminishes, only a portion of the filter is removed through a small opening in the access port 144 so that another liner may be implanted. Alternatively, the filter element may comprise multiple liners so that as an old liner is removed, the underlying fresh liner is exposed. Additionally, if the liner gets clogged so that the permeability of the liner is reduced it may also be replaced.

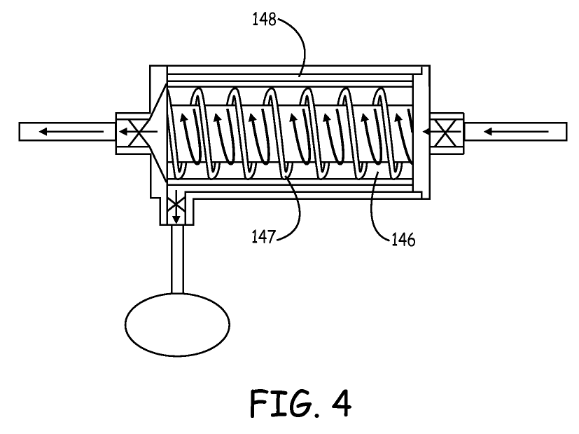

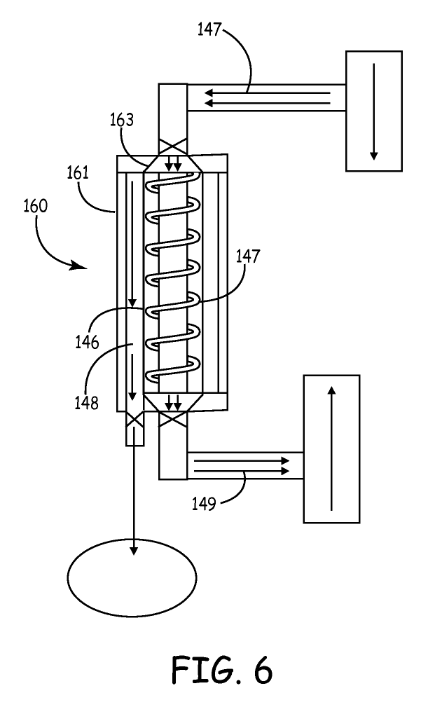

FIGS. 4 and 6, shows another implantable device with an alternative constructions. The filter element 146 separates the path of the blood flow from the collector 148. The filter element 146 has a large surface area in contact with a large surface area of the collector 148. Blood path modifier 147 is shown as a helical device that modifies the blood flow path. In doing so, different characteristics of the blood may be leveraged for a desired effect. In one embodiment, shown here, the helical device is designed to ensure laminar flow and to increase the contact time of the blood with the filter element 146. Furthermore, it reduces or eliminates short-circuiting, increasing dwell time, and reducing clotting and coagulation. One should also note the difference between the two constructions. It is conceived that the device depicted in FIG. 6 should is better suited for a vertical orientation in the body, because of the gravity feed downwards, whereas, the device in FIG. 4 is better suited for horizontal orientation if correctly positioned with the drain pointing downward. However, although they have their different designed purposes, it is conceivable that they will work in either orientation.

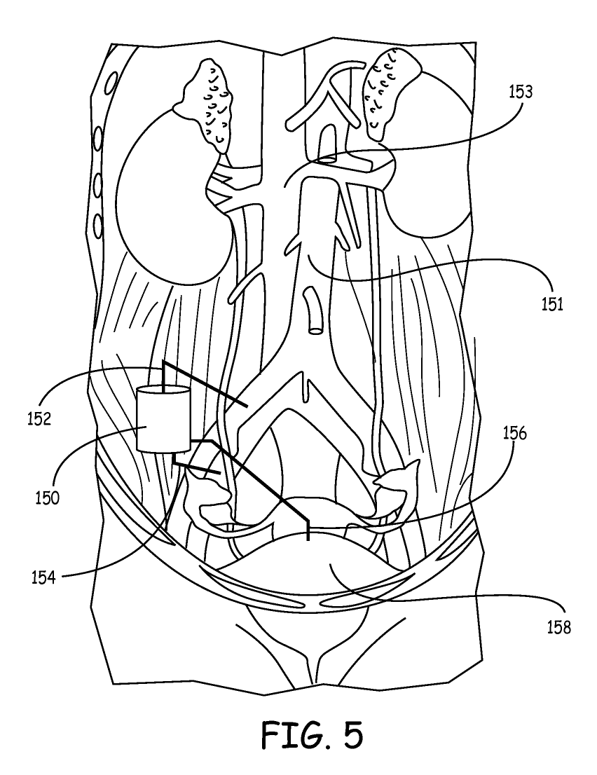

FIG. 5 illustrates one possible implantable location for the fluid removal device. In this scenario, a doctor would implant the housing 150 inside the abdominal cavity. The blood inlet 152 would be connected to the iliac artery 151 and the blood outlet 154 would be connected to the iliac vein 153. As such, the pressure drop between the artery and the vein could be used to force the blood through the device with certain undesired blood components being forced through a membrane or filter thus separating a fraction from the blood. The housing 150 would also have a waste connection 156 to the bladder or otherwise, including the urinary tract, the ureter, the urethra, an internal or external holding device such as a bag, or just external the body, for example through an access port, to facilitate disposal of the fractions extracted from the blood. The body connections are common vascular graft materials that are attached to the source artery, sink vein and bladder using known anastomotic techniques.

The device should be less than 1000 cL in size for implantation. In order to be able to implant the fluid removal device in more body types the device should be as small as possible. This device is conceived to have an occupied volume of less than 400 cL, which will allow implantation into a great majority of adult body types. The device may also be even smaller if lesser performance is necessary or if less space is available, for example, in a child.

FIG. 6 shows a fluid removal device 160 comprising a housing 161 which has a separation means or filter 146. The filter 146 is placed about to form a lumen 163. The blood 147 moves through the lumen 163 around a preferred blood path which may be a spiral or helix or channel so that the blood comes into contact with the filter 146. As the blood comes into contact with the filter or membrane, the fluids to be removed are forced through the filter into the collector 148 where the fluid is collected. The fluid is then discharged. The blood 149 is returned to the cardiovascular system. In order to change the membrane in this embodiment, a doctor would use the cardiovascular system as an access port, typically entering the cardiovascular system through the femoral artery and then navigating through the vasculature to the location where the device was grafted into the cardiovascular system. Alternatively, a doctor may also gain access through the femoral vein if the device is connected to by a graft to the vein.

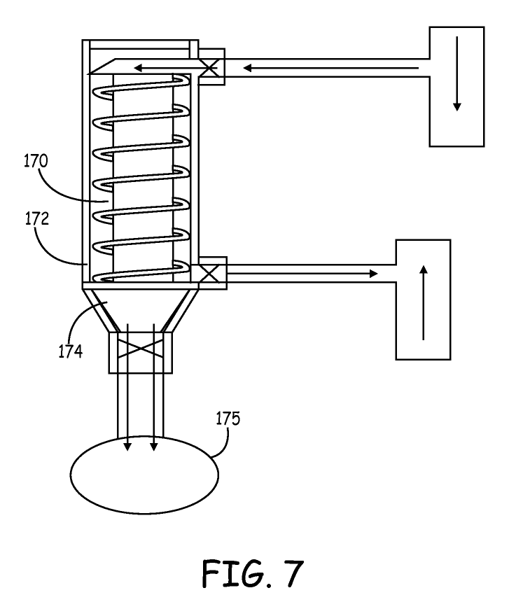

FIG. 7 depicts another variant of the invention. In this concept the blood comes into contact with the filter element 170 and the fraction to be removed passes through the filter to the collector 172. The collector then converges into a sump 174 at the bottom of the fluid removal device whereby the filtered matter may be discharged. The particles that can pass through the particulate filter 170 do so and collect and drain to the bladder 175.

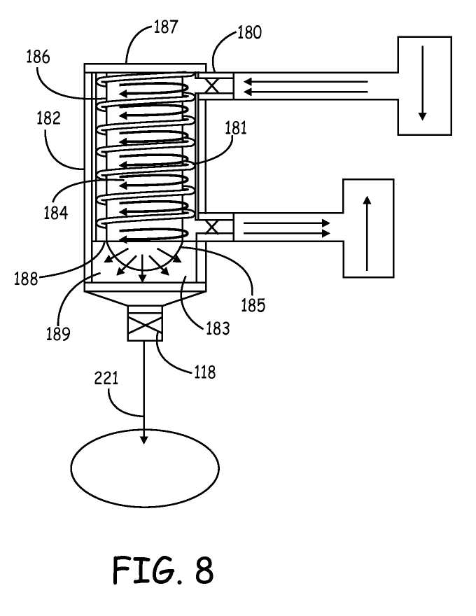

FIG. 8 illustrates another embodiment of the invention. In this embodiment, the fluid removal device comprises an inlet valve 180 to help prevent back flow. The housing 182 is divided into two chambers a blood path side 181 and a particulate filter side 183. The two sides are separated by an impervious or nearly impervious layer 188. Inside housing 182, is a blood flow path 184, in this case, it is in a spiral shape. As the blood spirals around the blood flow path 184, it comes in contact with a filter 186. The filter 186 is the replaceable component which separates water and salts from the blood. The filter 186 requires pore sizes which prohibit the crossing of large molecules such as the proteins, blood cells and other blood components while allowing other components such as water and salt ions to cross freely. Beyond pore size, a key requirement is that the filter or membrane 186 be non-thrombogenic. This can be achieved by material selection, coatings and electropolarization. Electronegative hydrophobic biomaterial prevents proteins (fibrin, thrombin, and albumin), RBC and platelets from fouling the filter membrane. Other factors that should be considered to produce a membrane that meets at least one object of the invention are pore size/shape/distribution, porosity, permeability, compaction, molecular weight cutoff (MWCO), and wall thickness. In one embodiment, the filter or membrane pore size is less than about 5 microns and achieves a slow, continuous water removal at a rate of less than or equal to about 3 mL/min, more specifically with a rate of 1-2 mL/min, while maintaining fluid, sodium and potassium homeostasis. It is also desired that in one embodiment that pore sizes are selected to prevent RBC (8 μm) & platelets (4 μm) from entering the wall microstructure and blocking water removal. The MWCO in one embodiment is 50,000 Daltons (Da) (the kidney's glomerulus basement membrane MWCO is 50,000 Da). As different molecules pass through the filter 186 they will collect inside a lumen 187. The lumen 187 extends from the blood path side 181 to the ultrafiltrate side 183. The removed material from the blood may be discharged directly into the ultrafiltrate side 183 or may pass through another filter 185 and then even through a particulate filter 189 if necessary. The material 221 flows through the valve 118 to the bladder.

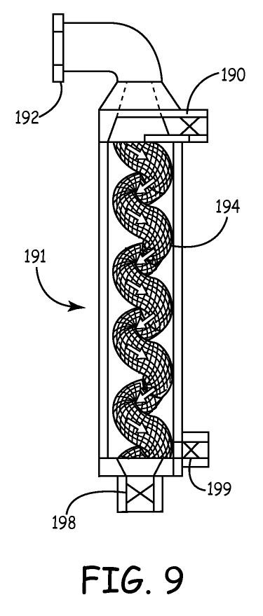

In FIG. 9, the device comprises an access port 192 whereby the interior of housing 191 may be accessed. A blood inflow valve 190 controls the flow of blood into the housing. Inside the housing 191, is a filter 194 which forms a channel for blood to flow through. The filter 194 is connected to the outflow valve 199 which is, in one embodiment, a restrictor hemostasis valve. Again the filter 194 is porous so that only certain components of the blood may flow through the filter 194. In one embodiment, the housing 191 may be filled with particulate so that as components of the blood flow through the membrane or filter they get filtered again by the particulate and pass outside the housing 191 through restrictor valve 198 and are drained from the body.

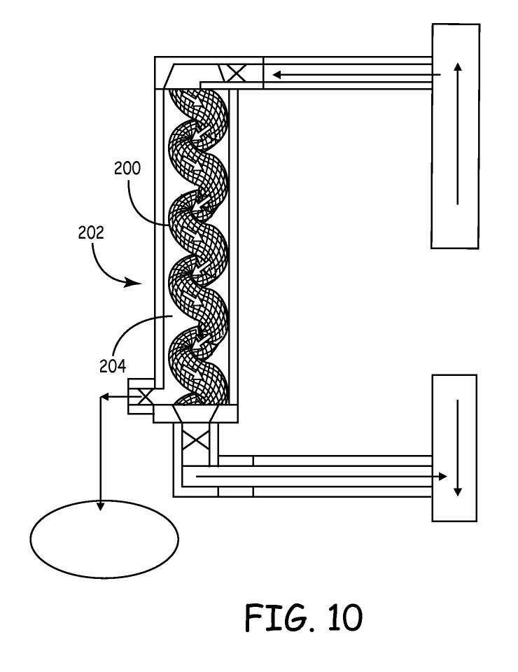

FIG. 10 shows another embodiment that has a tubular membrane 200 in housing 202. The tubular membrane 200 is in a helical shape to, among other things, reduce housing 202 volume and better force the blood and its components against the membrane. It is important to note that the membrane 200 may be surrounded by particulate filter 204. The membrane length may be adjusted so as to have additional surface area of the membrane so that the membrane contacts more blood. Additionally, the amount of filtrate may be regulated. Adjusting the length of the membrane, the membrane pores, the type size and shape of particulate filter, and/or the valves are some of the ways to regulate the amount of water, electrolytes and other things that are or are not removed from the blood.

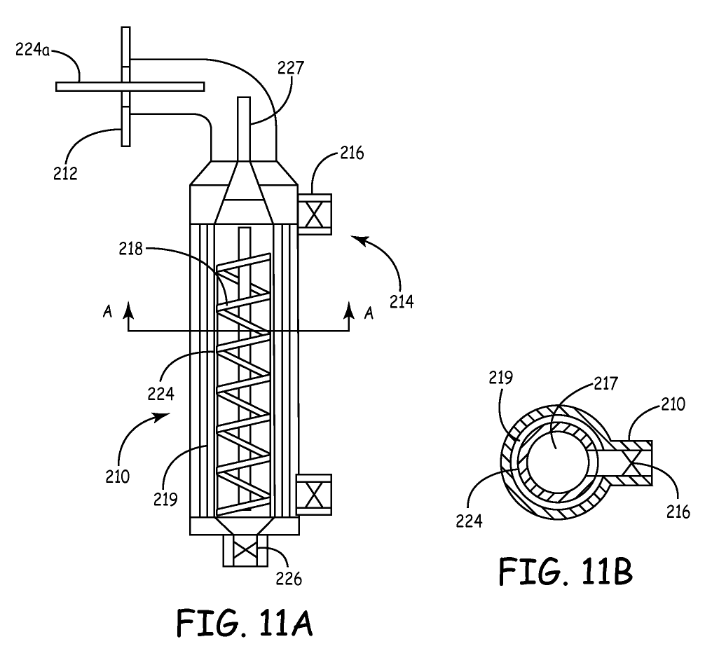

FIG. 11 shows another device according to an embodiment of the invention. The device comprises a housing 210 connected to a superficial access port 212. Similar to other constructions, it has an inlet 214 which may have valve 216 for blood to enter the housing from an artery. The blood moves into the central part of the housing. Inside the central part of the housing are spiral blood channels 218 that force the blood against the filter 224. The filter 224 is positioned, away from the housing wall so that fluid may accumulate on a collector side 219 of the filter 224 opposite the side where the blood is located 217. The fluid accumulates around the perimeter of the membrane and is drained through the outlet 226 to a bag, bladder or other device. The flow of the fluid is controlled by a valve that does not permit backflow from the collection device into the housing 210. The blood returns to the cardiovascular system. In some instances it flows to the veinous side, and in others it flows to a downstream arterial side. FIG. 11b is a cross-section of the device in FIG. 11a along lines A-A, showing the separation between the collector 219 and the blood path side 217.

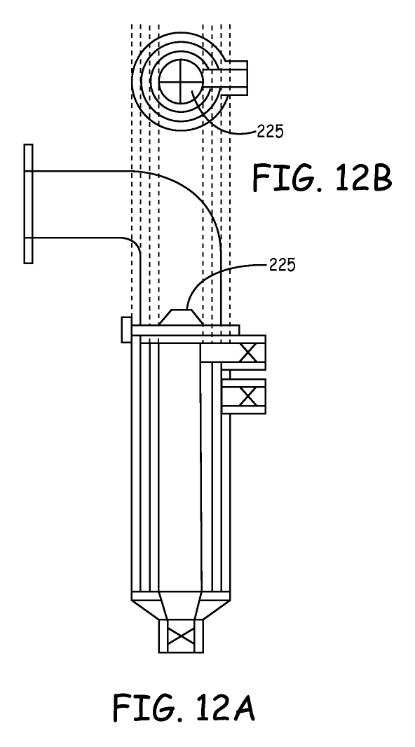

FIGS. 12a and 12b are similar to FIGS. 11a and 11b. However, FIG. 12b shows a self-closing entry 225 through which the membrane can be placed inside the housing 210. In FIG. 11b a compressed filter 224a slides around an impermeable end 227 and expands and seals against the end so that blood does not leak through the access port 212.

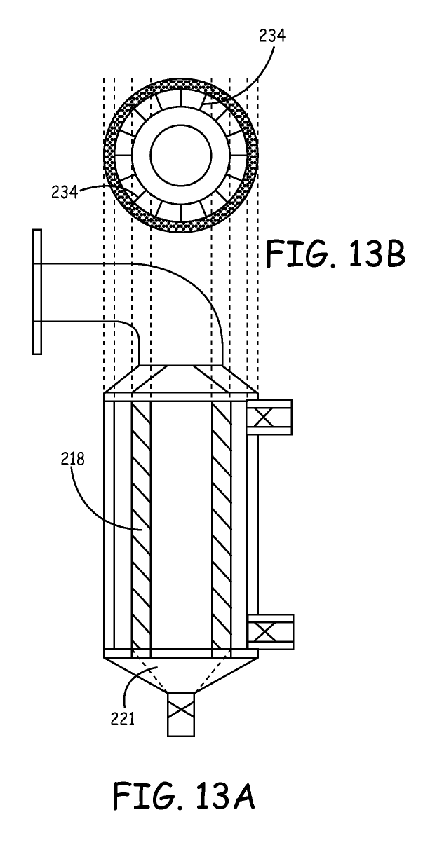

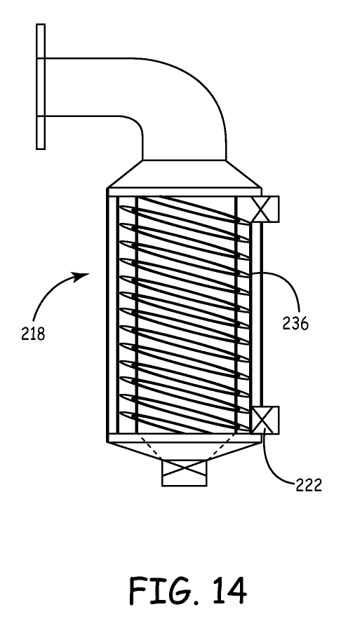

FIG. 13a shows a fluid removal device that operates in a similar fashion to the other devices but the structure is different. Instead of having the blood flow inside the filter 218 and the fluid collect outside of the filter 218 as in FIGS. 11a and 12a, the fluid flow collects inside the filter 218 before moving to collector 221. In FIG. 13b, axial channels 234 direct the flow of blood around membrane. A particulate filter may be placed inside the filter 218 to further filter the fraction removed from the blood or to react with waste. Similarly, FIG. 14 shows a fluid removal device with a center void for collecting fluid. After entering the device 210 the blood flows in spiral blood channels 236 until exiting out blood outlet 220 through valve 222.

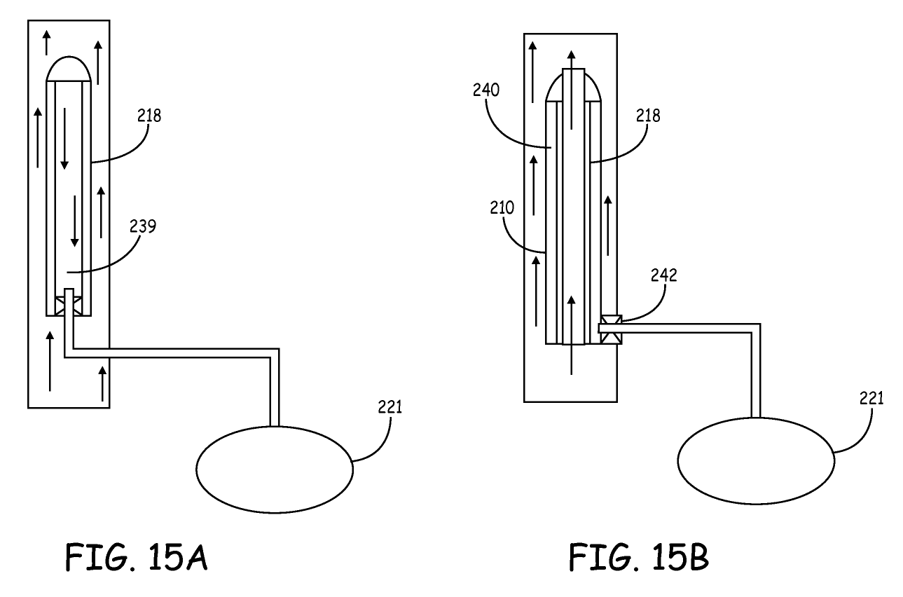

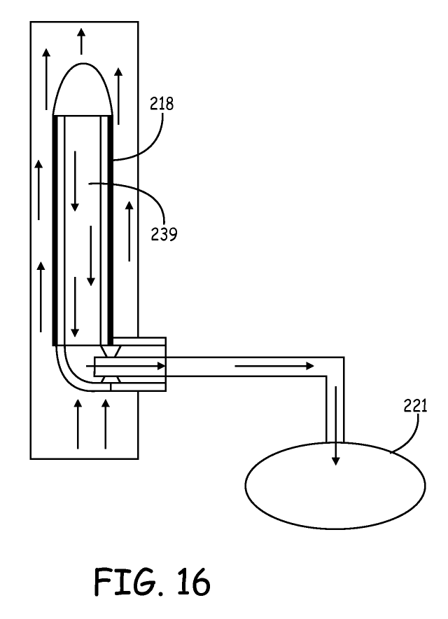

In FIGS. 15A and 16, which show intravascular placement, are similar in structure to FIG. 14, the blood flows outside membrane or filter 218. The fluid flows from the blood through membrane 218 into the lumen 239 created by the membrane 218. The fluid accumulates in the lumen 239 out of the filter to the collector 221.

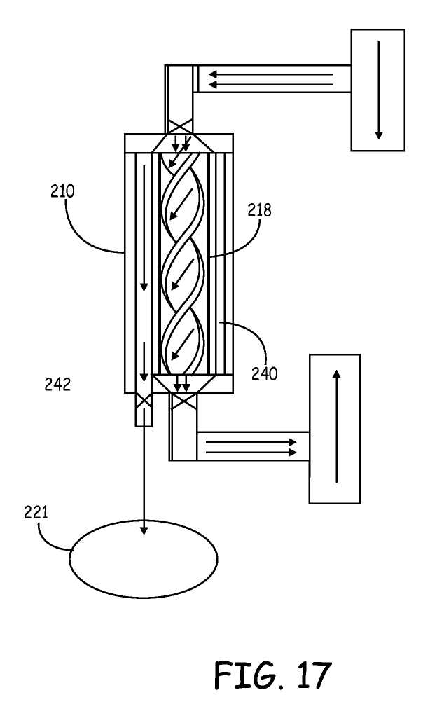

FIGS. 15B and 17, which are similar in structure to FIG. 11a, have blood flowing through a lumen created by filter 218. An outer lumen 240 is created by filter 218 and housing 210 through which the fluid passes as it exits restrictor valve 242 and passes to collector 221.

The devices in FIGS. 15 A and 15 B and 16 are placed directly in an artery or vein. These devices are readily accessible through percutaneous catheter techniques for replacing filters, and repositioning and removing the device.

It is important to note that all the membranes disclosed may comprise multiple layers so that at least one layer of the membrane may be replaceable if it becomes clogged or damaged so that the entire device does not have to be replaced. The membrane should have a pore size less than or equal to 5 microns. If the membrane has multiple layers, the membrane pores within each layer may be sized to specifically prevent certain blood components from passing through the membrane. It is conceived in one embodiment that the membrane size is approximately 1-10 cm in length. The outer diameter of the membrane may be 6-10 mm. The total exposed surface area of the membrane would be between 10 cm̂2 and 100 cm̂2. It is also conceived that the removable membrane layer may fit in less than a 15 French catheter and preferably in less than 10 French and even 6 French depending on the size and thickness of the membrane. Furthermore, it is conceived that the membrane may be integrated with Ni—Ti or other shape memory alloy or pseudoelastic alloy to self expand once the membrane is released from the catheter or other delivery device.

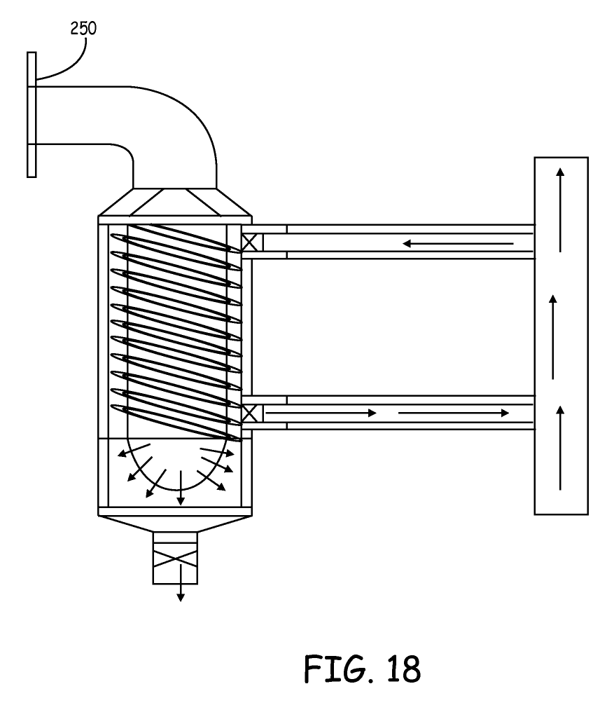

FIG. 18 is similar to FIG. 8 in structure; however the device shown in FIG. 18 has a superficial access port 250 to allow access to the device and membrane.

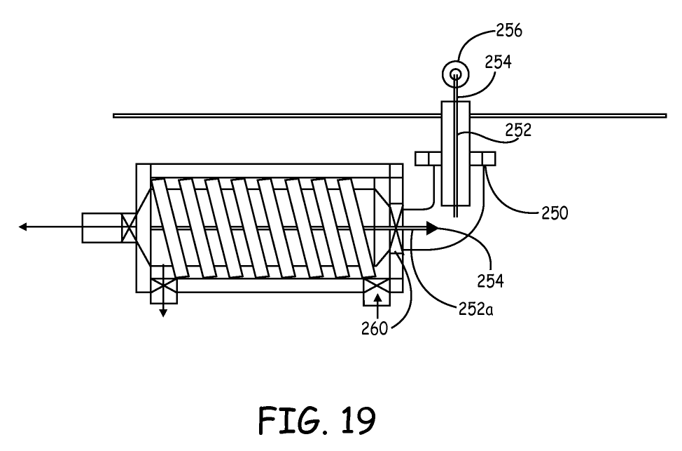

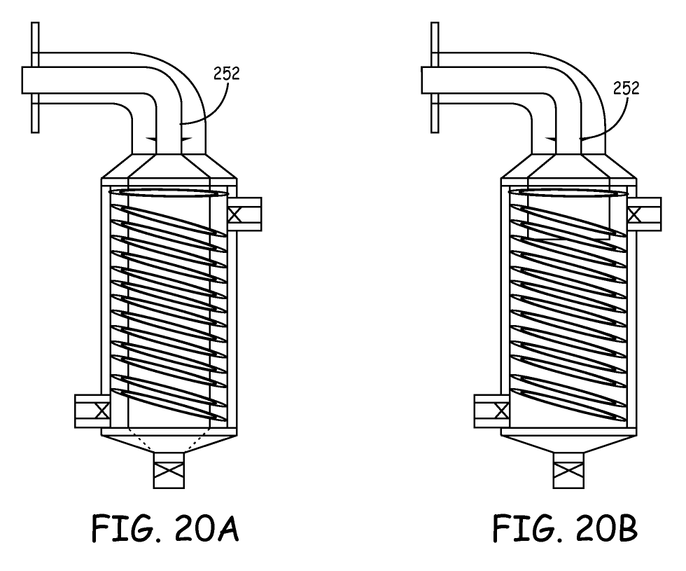

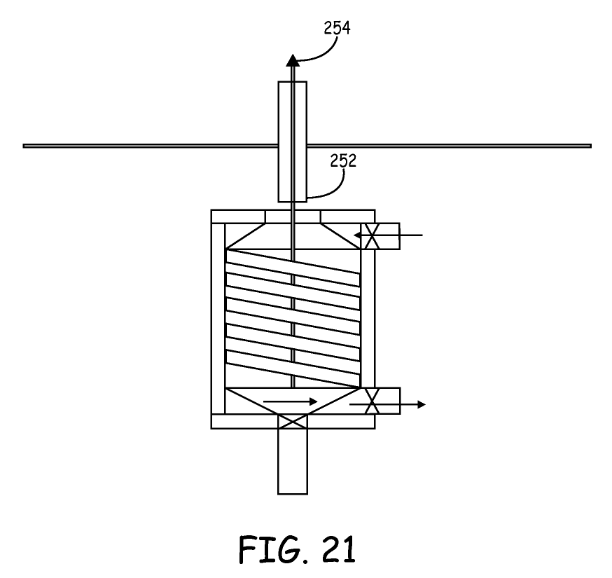

FIGS. 19 and 20a and 20b and 21 show a collapsed membrane 252 being placed through an access port 250. The membrane 252 has a retrieval wire 254 that is connected to the membrane 252a. The retrieval wire 254 may have a bulbous end 256 that allows easier percutaneous recapture through the use of a snare. Membrane 258 is the expanded membrane 252 in position within the fluid removal device. Membrane 258 has the retrieval wire extruding through a hemostasis valve 260. In operation, a doctor would introduce a snare through the access port 250 and snare end 256 of retrieval wire 254. The doctor would pull on the snare. By pulling on the snare the membrane would move through the hemostasis valve and eventually through the access port 250. The doctor would then introduce a new membrane through the access port and the hemostasis valve 260. The doctor would extrude the membrane or membrane layer from the catheter into position within the housing. After ensuring that the membrane or membrane layer is properly seated and there are no leaks, the doctor would retract the catheter.

This invention has been described herein in considerable detail in order to comply with the Patent Statutes and to provide those skilled in the art with the information needed to apply the novel principles and to construct and use the embodiments of the example as required. However, it is to be understood that specifically different devices can carry out the invention and that various modifications can be accomplished without departing form the scope of the invention itself.

We claim:

1. An implantable fluid filtration device with replaceable filter, a fluid filtration input port, a filtration fluid output port and a waste fluid output port wherein the replaceable filter comprises a membrane material.

2. The device in claim 1 wherein the implantable fluid filtration device is compatible with blood.

3. The device in claim 1 wherein the implantable fluid filtration device is compatible with cerebral spinal fluid.

4. The device in claim 1 wherein the implantable fluid filtration device is compatible with water and other waste products.

5. The device in claim 1 wherein the membrane material prevents passage of molecules greater than 5 microns.

6. The device in claim 1 wherein the replaceable filter membrane material prevents passage of molecules greater than 1 micron.

7. The device in claim 1 wherein the replaceable filter membrane comprises a thrombo-resistant material.

8. The device in claim 1 wherein the replaceable filter membrane comprises a microporous material.

9. The device in claim 8 wherein the microporous material comprises at least one of PTFE, expanded PTFE, polyethersulfone (PES) or polyurethane.

10. The device in claim 1 wherein the replaceable filter membrane material is coated with at least one of a drug or a bioactive material to modify, control or otherwise render the filter material thrombo-resistant.

11. The device in claim 1 wherein the device further comprises a flow restrictor.

12. The device according to claim 11 wherein the flow restrictor is adjustable to regulate the amount of fluid through the flow restrictor.

13. The device in claim 11 wherein the flow restrictor can stop fluid flow through the device.

14. The device in claim 11 wherein the flow restrictor may be located on at least one of the input port or output ports.

15. The device in claim 11 wherein the flow restrictor maintains a predetermined pressure across the filtration membrane.

16. The device in claim 1 wherein fluid flow at the waste fluid output port is less than 600 cubic centimeters per hour.

17. The device in claim 1 wherein the device has an overall volume less than 400 cubic centimeters.

18. The device in claim 1 wherein the input port is connected to an arterial system.

19. The device in claim 1 wherein the filtration fluid output port is connected to the venous system.

20. The device in claim 1 wherein the waste fluid output port is connected to one of the ureter, or the bladder.

21. The device in claim 1 wherein the waste fluid output port is percutaneously connected to an external collection device.

22. A method of periodically replacing the filter membrane material in the implantable fluid filtration device comprising the steps providing a filtration device, extracting filter membrane material from the device, and inserting a new filter membrane material.

23. A method of claim 22 wherein the filter membrane material is replaceable through subcutaneous access to the device.

24. A method of claim 22 wherein the filter membrane material is replaceable though the urinary tract.

25. A method of claim 22 wherein the filter membrane material is replaceable through a percutaneous access port.

26. A method of claim 22 wherein the filter membrane material is replaceable through venous or arterial access.

27. A method of claim 22 wherein the filter membrane material is replaceable through a surgical cut down.

28. A method of claim 22 wherein the method further comprises back-flushing the filter membrane to remove any build up of material which may foul it.
